(19) United States
(12) Patent Application Publication
(10) Pub. No.: US 2003/0048269 A1
(43) Pub. Date: Mar. 13, 2003

(54) System and method for generating finite element models

(76) Inventors: Donald T. Powell, Auburn, WA (US); Shaun Allahyari, Mercer Island, WA (US); Gian S. Aneja, Sammamish, WA (US); Mike Mo-Shi Hsu, Sammamish, WA (US)

Correspondence Address: BLACK LOWE & GRAHAM, 816 SECOND AVE., SEATTLE, WA, 98104, US

(21) Appl. No.: 09/952,026

(22) Filed: Sep. 12, 2001

(51) Int. Cl. G06T 17/00

(52) U.S. Cl. 345/420

(57) ABSTRACT

A system and method for automatically and rapidly generating a finite element model of a component are provided. A two-dimensional diagram of points and lines that represent geometry of a component is input. A first input file is created from the two-dimensional diagram. The first input file defines geometrical structure of the component. A second input file is created that defines properties and materials of the component. The properties and materials are defined responsive to the geometrical structure of the component, and are defined according to a predetermined set of properties and materials rules for the component. Without any surfaces being generated to define geometrical structure of the component, a finite element model of the component is generated from the defined geometrical structure of the component and the defined properties and materials of the component.

### FIELD OF THE INVENTION

This invention relates generally to engineering design tools and, more specifically, to finite element model generation tools.

### BACKGROUND OF THE INVENTION

Designing and building complex systems, such as aircraft, space vehicles, marine vessels, marine platforms such as oil rigs, land vehicles such as automobiles and trucks, and the like, is a complex process that involves several disciplines. For example, typically several years of design, testing, analysis, and systems integration are performed before a complex system is put into operation. Furthermore, before a component, subassembly, or assembly is built, a design for the component, subassembly, or assembly is analyzed.

Such an analysis typically entails generating a mathematical model, such as a finite element model, of the component, subassembly, or assembly. The finite element model is a three dimensional, mathematical definition of a component. The model includes surfaces and exhibits geometric properties, material properties, mass, stiffness, and the like. The finite element model can be subjected to static and dynamic testing. Thus, use of mathematical models such as finite element models greatly reduces time and labor to analyze components over building, testing, and analyzing physical models.

However, generating finite element models of components or subassemblies in complex systems, using currently known methods, is a time-consuming and labor-intensive process. Further, generating finite element models of components in complex systems entails engineering efforts across several disciplines. For example, developing a finite element model for all of the major components for mounting an engine under a wing of a commercial airplane, involves a cross-disciplinary team of loads engineers, stress engineers, designers, and weights engineers.

Typically, engineers from each discipline will develop, from a set of requirements, a preliminary design document. From the preliminary design document, a designer configures a two-dimensional centerline preliminary design drawing. The preliminary design drawing represents definition of lines of a component, but the preliminary design drawing does not represent structure of the component. A designer takes the line definition from the preliminary design drawing and develops structural definition for the component. Structural definition includes assigning properties and materials, and gages. Next, a designer generates surfaces for the component based on the structural definition. Surface generation is a very detailed, time-consuming process.

In a series of manual operations, a modeler takes required information off the structural definition to generate a finite element model of the component. Generating the finite element model includes generating surfaces, structural breaks, and properties and materials for the component.

The surface geometry is transferred from a CAD computing environment to a modeling-computing environment such as UNIX. Because manually generated surfaces typically include flaws, the surfaces are cleaned up. For example, meshing operations in commercially-available modeling software may introduce surface flaws. In most cases, a surface is so flawed that the surface must be re-created.

Each surface is mesh-seeded. If the surface is not corrupted, grid and nodal generation is completed as desired. A limited number assignment to the mesh, that is grid and element numbers, is created.

Property and materials are assigned to the created elements. Mass is evaluated and changed, if desired. Finally, numbering errors are manually modified to allow proper interfacing with other finite element models.

The above process results in just one iteration of each component being modeled. Each model can then be subject to static and dynamic testing, as desired or required. Finally, all the finite element models are integrated into a model of a subassembly or assembly. Integration of the component models involves determining connection points and interface connections. When the component models are integrated into an integrated finite element model, documentation of the model is generated, and the model is released. The above process can take thousands of labor hours and hundreds of manufacturing days, and results in just one iteration of an integrated finite element model.

As a result, a first iteration of an integrated finite element model may not be released until well after a 25% design review and may not be released until a 90% design review. Such a long analysis cycle time introduces program risk and is unresponsive to unanticipated growth of work statements in complex system integration projects. Further, such a process is unresponsive to design changes.

Thus, there is an unmet need in the art for a rapid, automated system and method for generating finite element models that reduces analysis cycle time, reduces unanticipated work statement group, reduces program risk, and responds immediately to changes.

### SUMMARY OF THE INVENTION

The present invention is a system and method for generating finite element models that greatly reduces analysis cycle time, reduces unanticipated work statement group, reduces program risk, and responds immediately to changes, such as updates to geometry, mass, or stiffness. The invention rapidly and automatically inputs geometry, properties, and materials data from a preliminary design drawing sheet as points and lines in space and, without inputting any defined surfaces, rapidly models a defined structure of a component. The invention optionally performs basic static and dynamic analysis of the structure of the component, and integrates the component models into an integrated finite element model. Because geometry of a component is accurately specified as points and lines in space, the invention does not require surfaces for defining geometrical structure as an input to a modeling routine. As a result, accurate models are rapidly generated in a fraction of the time required by currently known techniques for generating models.

Automating the process of generating and integrating finite element models makes the process more consistent and reliable. Because the models are consistent, every model has element identification, property identification, and material identification. Analysis of the finite element models is thus standardized.

The invention provides a system and method for automatically and rapidly generating a finite element model of a component. A two-dimensional diagram of points and lines that represent geometry of a component is input. A first input file is created from the two-dimensional diagram. The first input file defines geometrical structure of the component. A second input file is created that defines properties and materials of the component. The properties and materials are defined responsive to the geometrical structure of the component, and are defined according to a predetermined set of properties and materials rules for the component. Without any surfaces being required to define geometrical structure of the component as an input to a modeling routine, a finite element model of the component is generated from the defined geometrical structure of the component and the defined properties and materials of the component.

### BRIEF DESCRIPTION OF THE DRAWINGS

The preferred and alternative embodiments of the present invention are described in detail below with reference to the following drawings.

FIG. 1 is a block diagram of an exemplary host platform;

FIG. 2 is a representative drawing sheet template;

FIG. 3 is a representative two-dimensional centerline diagram;

FIG. 4 is a flow chart of a routine for generating geometrical structure inputs and properties and material input;

FIG. 4A is a diagram showing geometry definition for a component;

FIG. 4B is a diagram showing properties and material related to geometry of a component;

FIGS. 5A, 5B, and 5C are flow charts of routines for generating a finite element model;

FIG. 6 is a flow chart of a routine for performing checkout and analysis of a finite element model;

FIG. 7 is a flow chart of a routine for generating initial loads and sizing of a finite element model;

FIG. 8 is a flow chart of a routine for integrating finite element models; and

FIGS. 9A-9N are screen shots of an example of finite element model generation according to an embodiment of the invention.

### DETAILED DESCRIPTION OF THE INVENTION

The present invention is a system and method for automatically and rapidly generating a finite element model of a component. A two-dimensional diagram of points and lines that represent the geometry of a component is created. A first input file is created from the two-dimensional diagram. The first input file defines geometrical structure of the component. A second input file is created that defines properties and materials of the components. The properties and materials are defined responsive to the geometrical structure of the component, and are defined according to a predetermined set of properties and materials rules for the component. Without any surfaces being generated to define geometrical structure of the component, a finite element model of the component is generated from the defined geometrical structure of the component and the defined properties and materials of the component.

An exemplary host platform for the system of the invention will first be described. Then, routines for performing a method of the invention will be described. Finally, a non-limiting example of model generation according to the invention will be described.

Exemplary Host Platform

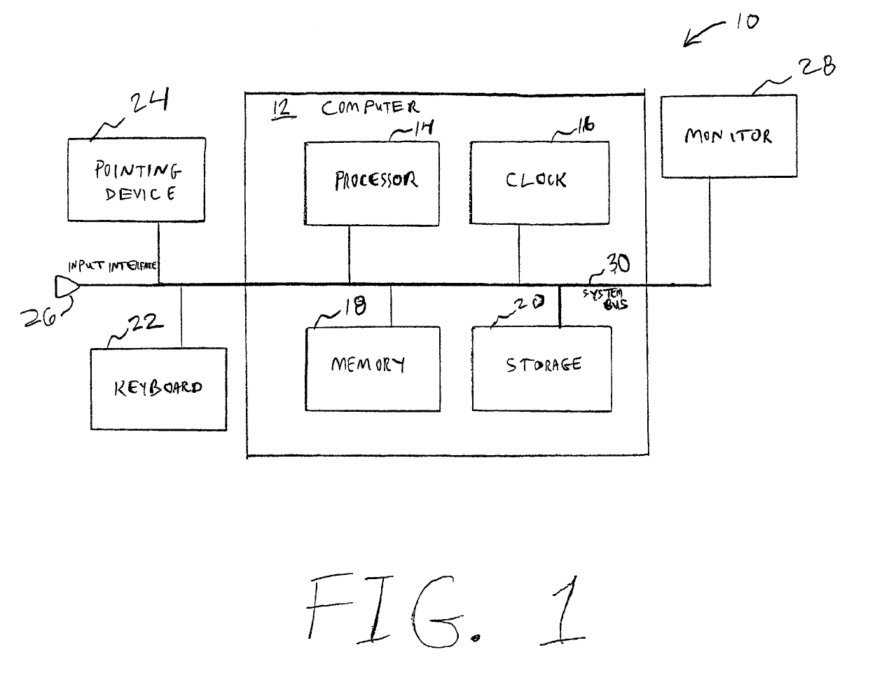

FIG. 1 shows a block diagram of an exemplary host platform 10 that is suitable for hosting software routines according to the invention. The platform 10 includes a computer 12. The computer 12 is suitably any computer that is arranged for performing computer-aided-design (CAD) functions or computer-aided-engineering (CAE) functions. As is known, the computer 12 includes a processor 14 that is controlled by a clock 16. The computer 12 also includes memory 18, such as random access memory (RAM). The computer 12 also includes storage 20 such as a hard disc drive, a compact disc (CD) drive, a zip disc drive, a floppy disc drive, or the like. The computer 12, including the processor 14, is suitably arranged to operate in any acceptable operating system environment that supports CAD or CAE applications. Suitable operating system environments include UNIX, Linux, Windows, Macintosh, and DOS.

The host platform 10 also includes input devices such as a keyboard 22 and a pointing device 24, such as a mouse, a touch pad, a track ball, or the like. The host platform 10 also includes an input interface device 26 that is arranged to interface the host platform 10 with other computing platforms, such as a CATIA workstation, and with other sources of input data. The host platform 10 also includes a monitor 28. A system bus 30 interconnects all components of the host platform 10.

The host platform 10 thus includes platforms such as UNIX workstations, personal computers, and Macintosh computers. For example, the exemplary host platform 10 is suitably a UNIX workstation, such as an IBM RS6000 workstation. Because these platforms are well known, further description of their construction and operation is not necessary for an understanding of the invention.

Integrated Finite Element Model Generation

According to the present invention, a process is provided for rapidly generating an integrated finite element model of a component, subassembly, or assembly. The process includes five major modules: (1) input file generation; (2) finite element model generation; (3) model checkout; (4) initial loads and sizing; and (5) integrated finite element model generation. Each of these modules is discussed below in detail.

(1) Input File Generation

The process of generating finite element models is automated through use of standardized input files that are preferably derived from standardized drawing sheets or templates. The purposes of the template include: (1) communicating major elements of design of a component; (2) providing geometry information to create a finite element model; (3) providing all properties, material, and weights information to create a finite element model; (4) defining major structural assemblies; and (5) linking design, stress, loads, weights, and other engineering disciplines when configuring a new structure design.

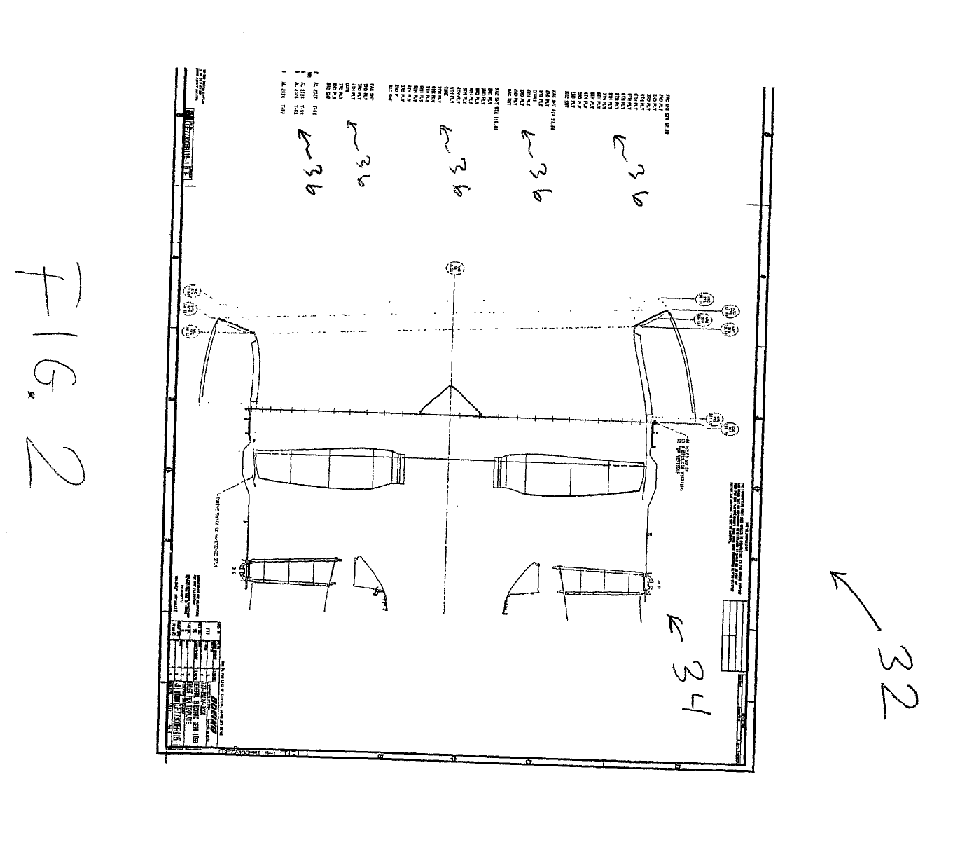

FIG. 2 is a representative drawing sheet template 32. The template 32 is a drawing sheet that is designed for modeling. Accordingly, the template 32 includes sufficient line information to define surfaces, structural breaks, properties, material, and mass. The template 32 includes representation of geometry of a component 34. For example, the component 34 shown in the template 32, given by way of non-limiting example, is a nacelle for an aircraft engine. The template 32 also includes information fields 36 that include information for the component 34 regarding geometry, properties, materials, and weights or mass data. Boundary conditions are predetermined.

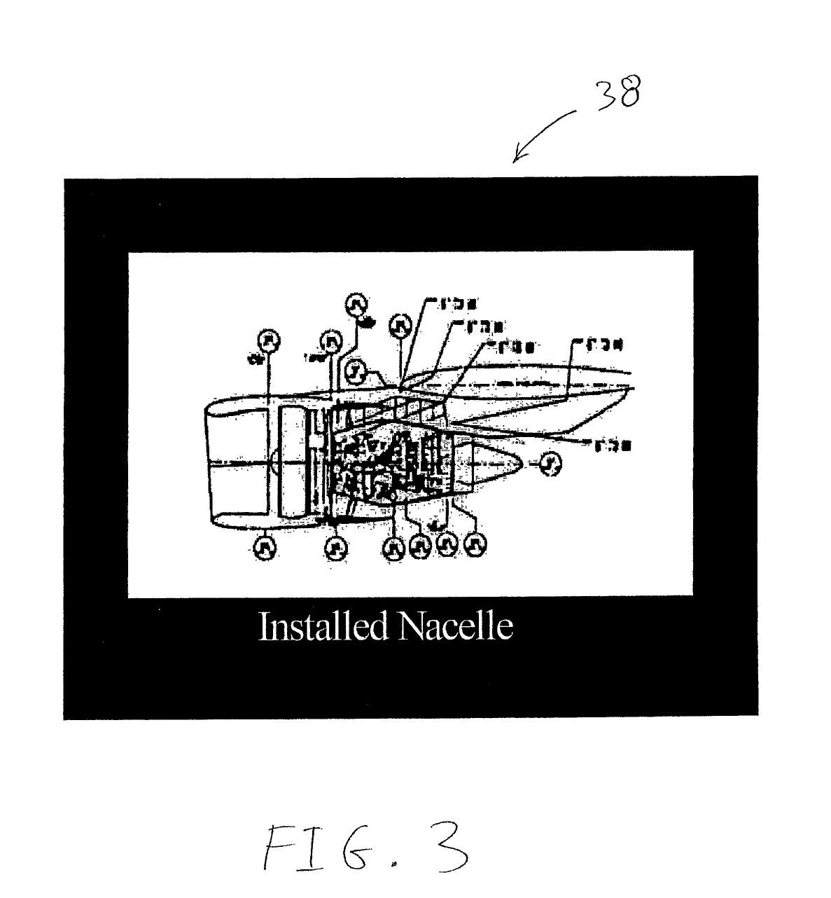

The template 32 is preferably generated from a two-dimensional centerline diagram 38, a representative example of which is shown in FIG. 3. Given by way of non-limiting example, the two-dimensional diagram 38 shown in FIG. 3 is a two-dimensional preliminary design centerline diagram of an installed nacelle for an aircraft engine. The centerline diagram 38 is suitably generated by an acceptable CAD program, such as, without limitation, CATIA, Unigraphics, or the like. The centerline diagram is transferred to the host platform 10 in computer readable medium such as a CATIA file, Unigraphics file, or the like. Because geometry representing structural configuration of a component begins with the two-dimensional diagram 38, from which the template 32 is preferably generated, it will be appreciated that geometry representing the structural configuration of a component is simplified to points and lines in space. As a result, unlike techniques currently known for defining geometry that represent structural configuration of a component, according to the present invention input of surfaces to a modeling routine is not required. Instead, the template 32 is developed such that details regarding points and lines in space that are contained within the template 32 are sufficient to communicate a preliminary design of a component. As a result, a subsequently created model will represent the current configuration that is defined on the template 32.

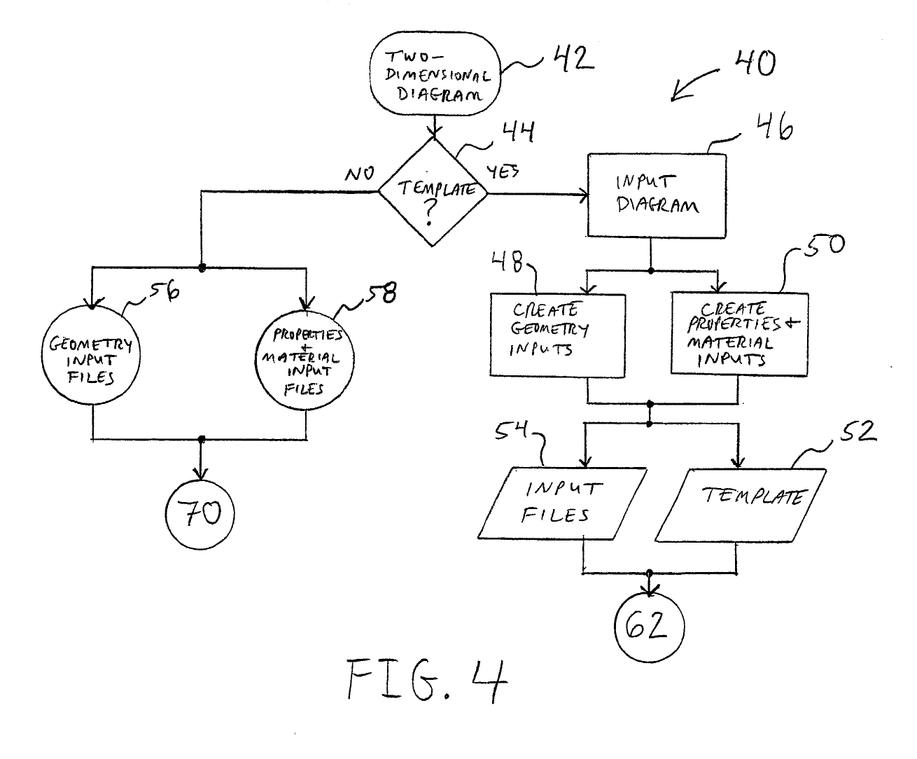

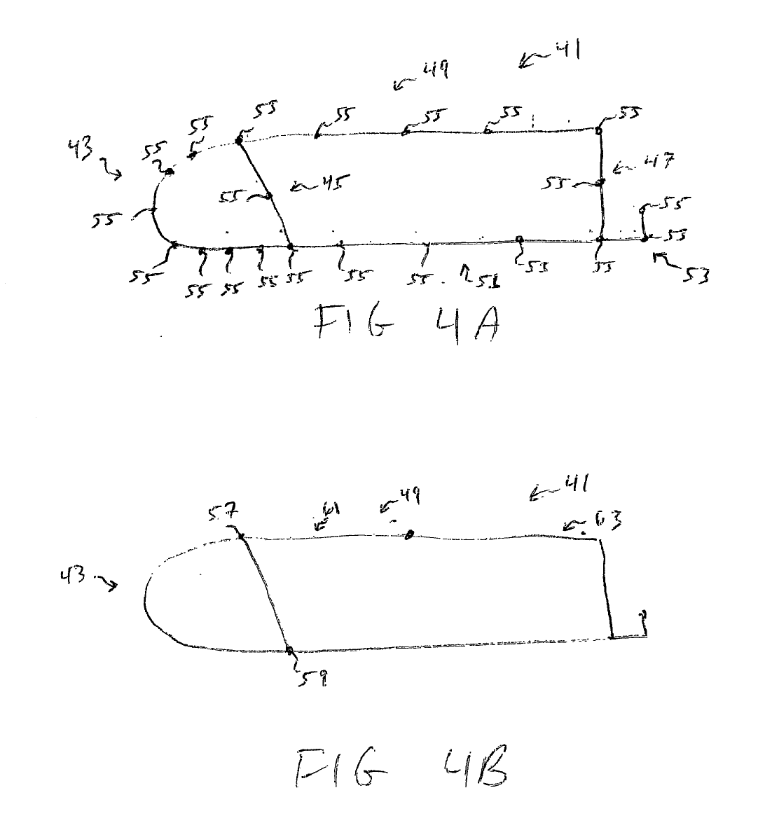

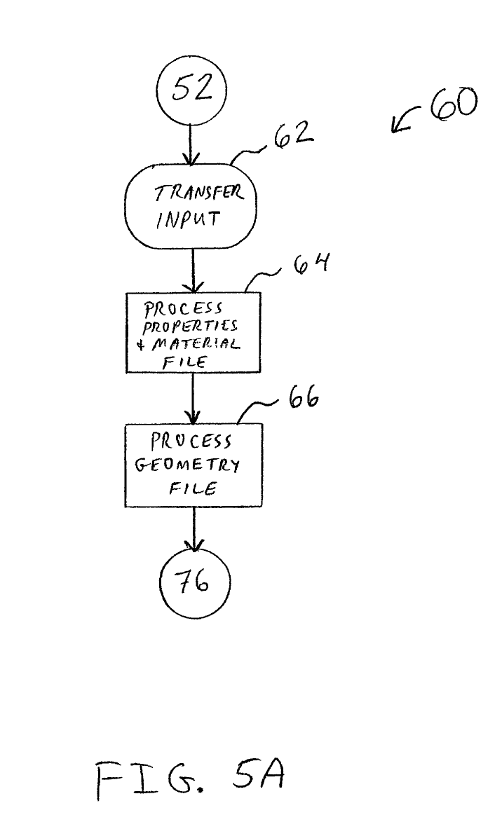

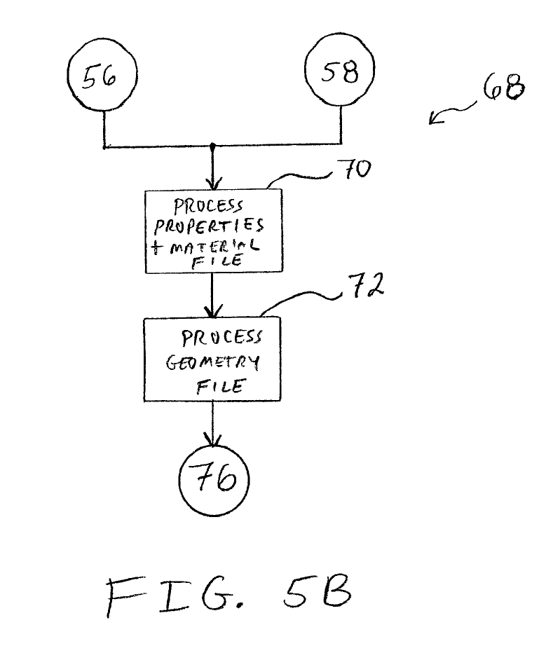

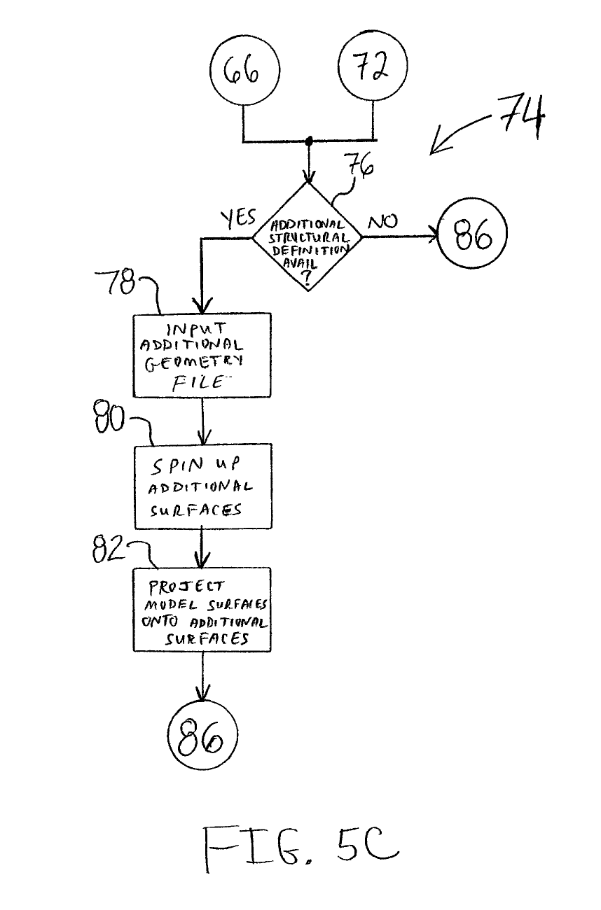

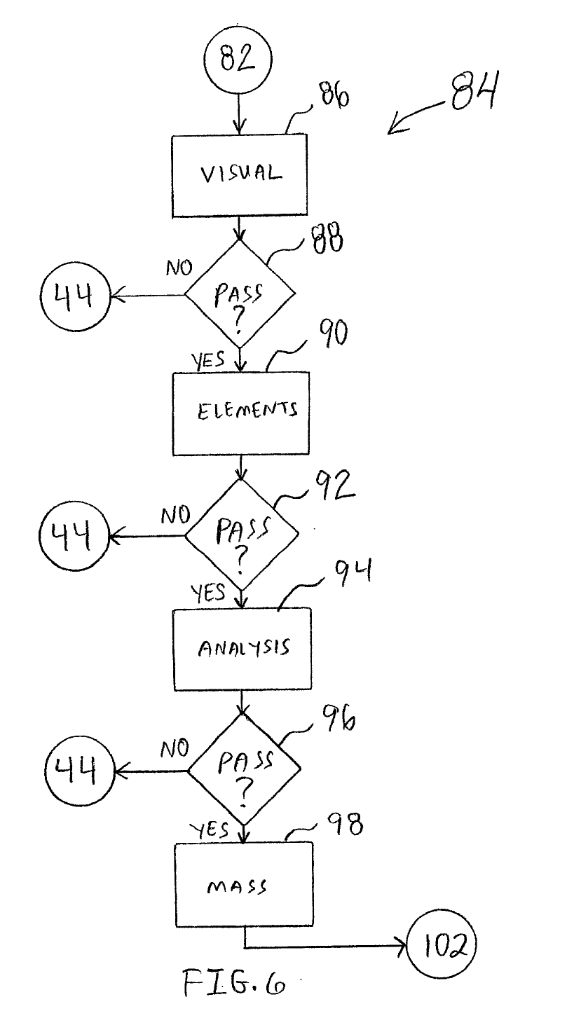

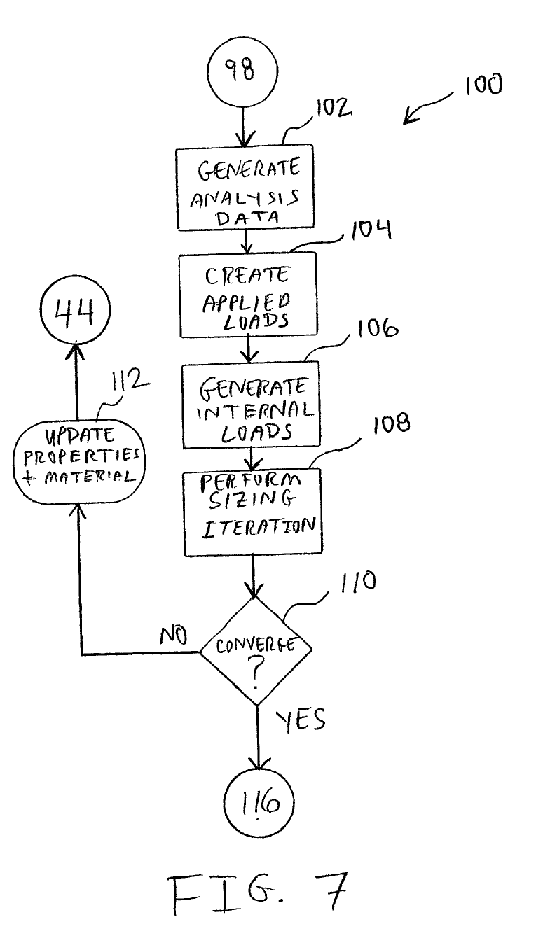

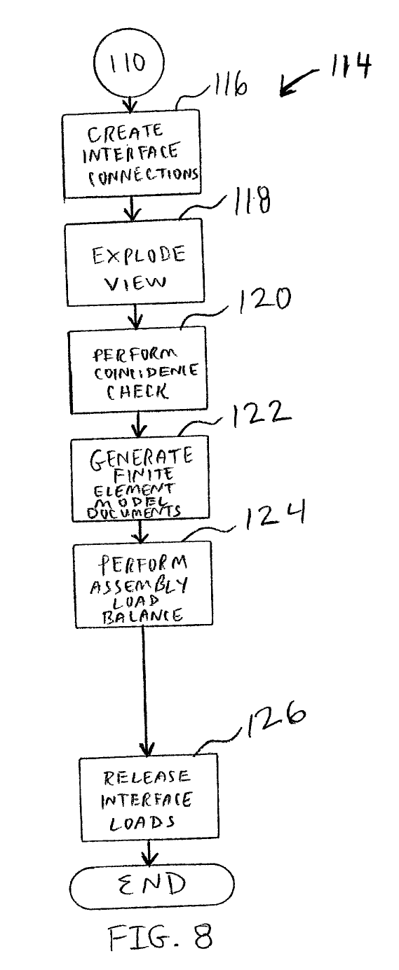

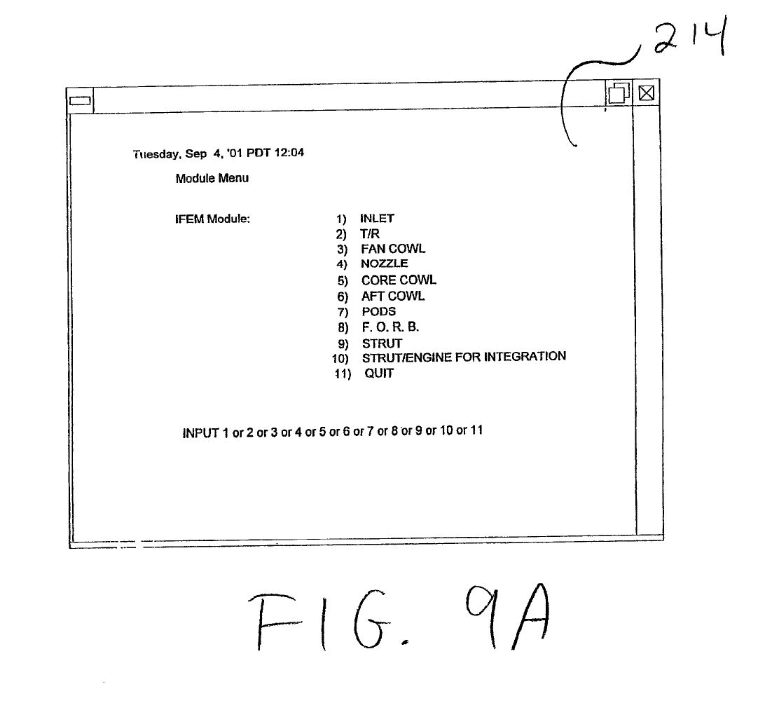

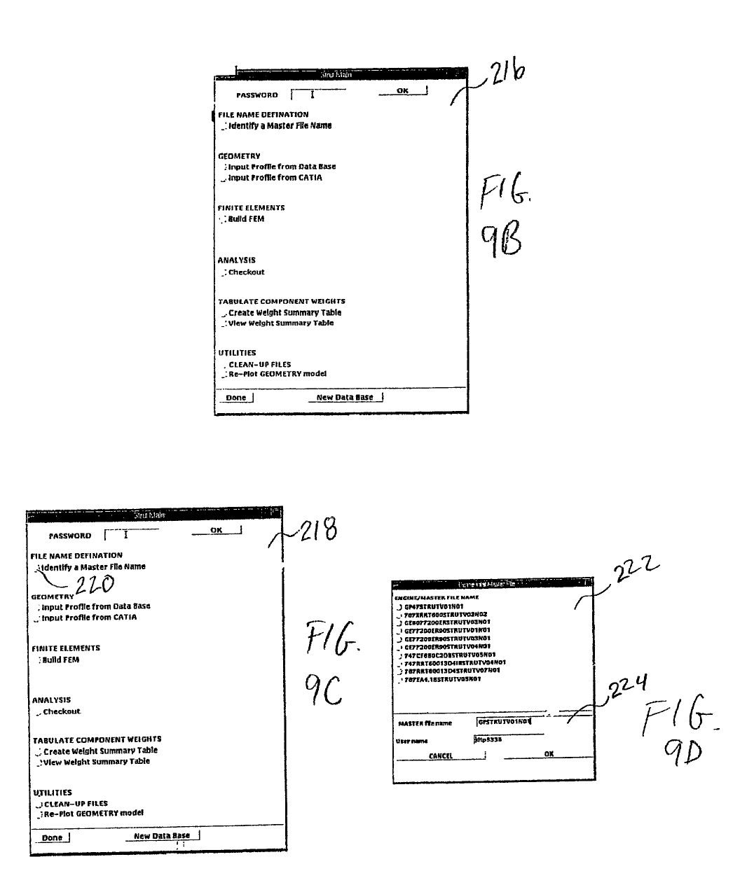

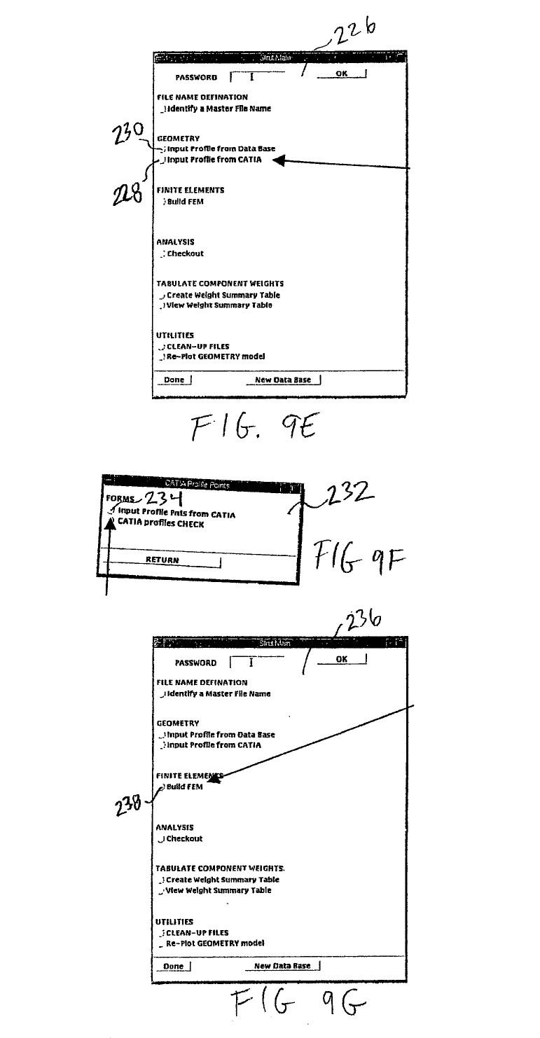

Generation of the template 32 will now be explained referring to FIG. 4. A routine 40 for generating inputs representing geometrical structure of a component begins at a block 42 with the two-dimensional diagram 38 being provided. According to the invention, the standardized input files are preferably generated through generation of the template 32. However, in other embodiments, the standardized input files are generated without use of the template 32—and such generation without use of the template 32 is suitably automated or manual. Accordingly, at a decision block 44, a determination is made whether or not geometrical structure inputs will be created using the template 32 or whether geometrical structure inputs will be manually or automatically created without the template 32.

If a determination is made that the geometrical structure inputs will be created using the template 32, the routine 40 proceeds to a block 46. At the block 46, the two-dimensional diagram 38 is input. For example, in one embodiment of the invention, the two-dimensioned diagram 38 is input to the host platform 10 from a CATIA workstation (not shown), via the input interface 26, as a CATIA file. The two-dimensional diagram 38 is preferably read automatically. The host platform 10 reads information regarding points and lines in space defining the geometry of the component 34. For example, an executable file, such as a FURTRAN, C, or PATRAN command language file, can be executed to automatically read information from the file containing the two-dimensional diagram 38. However, it will be appreciated that other command languages in other graphical user interfaces may be used as desired. The block 46 invokes a set of predetermined rules for the component 34. The set of predetermined rules relate property and materials for the component 34 to the geometry of the component 34. For example, if the component 34 geometrically defines ten bays, then the predetermined set of rules requires that the template 32 include ten inputs for property and material definition. However, it will be appreciated that any number of properties and material inputs may be specified as desired for any component. According to the invention, the property definition is predetermined for any component, thus automating the properties and material definition for mass and stiffness.

FIG. 4A shows an example of structural definition sufficient to describe surfaces and subassemblies of an inlet 41 for an aircraft engine. The structural subassemblies within the inlet 41 include a lip skin 43, a forward bulkhead 45, an aft bulkhead 47, an outer barrel 49, an inner barrel 51, and an attachment flange 53. All of these structural subassemblies are defined by the plurality of points 55. It will be appreciated that definition of the structure via the plurality of points 55 is sufficient for generating a surface.

FIG. 4B shows required input for property breaks related to the structural definition shown in FIG. 4A. As shown in FIG. 4B, the lip skin 43 requires no additional definition for property assignment, because the lip skin 43 is assumed to be monolythic. That is, thickness of the lip skin 43 is assumed to substantially constant between a subassembly break denoted by points 57 and 59 where the lip skin 43, the forward bulkhead 45, the outer barrel 49 and the inner barrel 51 intersect. However, a first property break 61 is defined for the outer barrel 49 between the point 57 and the a point 65. The first property break 61 includes a first set of properties and material definitions. A second property break 63 is provided between the points 55 and 59 and includes a second set of property and material definitions. The points 57, 59, and 65 coincide with selected individual points 55 shown in FIG. 4A. As a result, the outer barrel 49 includes multiple property breaks. As a result, the outer barrel 49 includes a section with material and property defined by the property break 61 and another section with properties and materials defined by the property break 63. It will be appreciated that the number of property breaks can be predetermined as desired for any particular component. Thus, the relation of properties and materials to geometrical structure, as shown in FIGS. 4A and 4B, are given by way of non-limiting example only.

Alternatively, in another embodiment of the invention, a designer manually reads information from the two-dimensional diagram 38 at the block 46. That is, a designer obtains information regarding points and lines in space that define the geometrical structure of the component 34 from the two-dimensional diagram 38. The designer also manually invokes the set of predetermined rules for the component 34.

The routine 40 proceeds to a block 48, at which geometrical structure of the component 34 is layered. For ease of processing, major structural assemblies of the component 34 are separated by layers. For example, a strut for mounting an aircraft engine is broken into nine major structural assemblies: spars; webs; skins; bulkheads; frames; struts and wing and fitting extensions; hinge fittings; and compression pad fittings. A file in an acceptable language, such as a PATRAN command language file, is suitably executed to layer the geometrical structure of the component 34. The layered geometry suitable resides in a file such as a *.ft1 file.

At a block 50, properties and materials are defined. As previously mentioned, the properties and materials for the component 34 are related to the geometrical structure of the component 34. For example, the number of bays of a component determines the number of inputs for properties and the number of inputs for material definition. At the block 50 the predetermined set of properties and materials rules is applied to the geometrical structure of the component 34. For example, the predetermined set of properties and materials rules may reside in a database that is populated with properties and materials entries for various components. As a result, properties and materials are defined for the component 34. For example, when the component 34 is a strut, the predetermined set of materials rules may predetermine that spars, bulk heads, frames, STW and backup, front weld fittings, hinge fittings, and compression pad fittings are made of metal. However, the predetermined set of materials rules may predetermine that webs and skins may be made of either metal or composite. The predetermined set of materials and properties rules also determines properties for each of the major structural assemblies of the component 34. Functionality of the block 50 is suitably performed by execution of any acceptable file, such as without limitation a PATRAN command language file.

At a block 52, the information fields 36 of the template 32 are populated with information regarding the geometrical structure of the component 34 and with information regarding properties and materials of the component 34, generated as described above at the blocks 48 and 50, respectively. Functionality of the block 52 is suitably performed by execution of any acceptable file, such as without limitation a PATRAN command language file. According to the invention, the template 32 is a CAD file, such as without limitation a CATIA file. The template 32, including the information fields 36 and a geometrical representation of the structure of the component 34, thus represents a description of the geometrical structure of the component 34 and the materials and properties of the component 34 in a human-readable form. This permits changes to the geometrical structure of the component 34 or the materials and properties of the component 34 to be entered either manually or automatically later in the design process. Thus, as a CAD file the template 32 can accommodate changes as a design matures or in response to changes in program requirements.

At a block 54, information regarding the geometrical structure of the component 34 is processed into an ASCII input file, such as a *.ft11 file, that is suitable for further processing by a finite element model generation routine. Similarly, information regarding the properties and materials of the component 34 is read from the information fields of the template 32 and is converted into an input file, such as a *.txt file, that is suitable for further processing by a finite element model generation routine. It will be appreciated that the blocks 52 and 54 may be performed simultaneously, if desired, to create the template 32 and the input files.

Referring back to the decision block 44, if a determination is made that a template will not be generated, manual input files are created. At a block 56, an ASCII file is manually created by a designer for geometrical structure input for the component 34. The geometrical structure ASCII input file is suitably a *.ft11 file. Similarly, at a block 58, an input file for properties and material input is created. The properties and material input file is suitably a *.txt file. Manual creation of the geometrical structure input file and the properties and material input file is performed by a designer applying the geometrical structure from the two-dimensional diagram 38 to the predetermined set of properties and materials rules for the component 34. Alternatively, the geometry input file and the properties and material input file can be automatically generated by a suitable CAD software application, such as without limitation ICAD.

The geometrical structure input file and the properties and material input file, regardless of whether the files are generated via creation of the template 32 or are manually or automatically created without the template 32, provide input to the next process according to the invention—finite element model generation—from a representation as only points and lines in space. Thus, according to the invention, the geometrical structure of the component 34 has been defined without generating any surfaces.

(2) Finite Element Model Generation

Two routines are available for generating a finite element model of the component 34. One routine generates a finite element model when a geometrical structure input file and a materials and properties input file are generated using the template 32. Another routine is available for generating the finite element model when the geometrical structure input file and the properties and materials input file are either manually or automatically generated without the template 32. Each of these routines are discussed below.

FIG. 5A shows a routine 60 for generating a finite element model of the component 34 when the geometrical structure input file and the properties and materials input file are generated from the template 32. That is, referring back to FIG. 4, the input files were generated by performance of blocks 46-54. It will be appreciated that the template 32 is suitably generated in a CAD environment, such as CATIA, Unigraphics, or any other suitable CAD environment known in the art. Generation of finite element models, however, is typically performed in a computing environment other than a CAD environment. For example, finite element models are suitably generated in a UNIX environment. It will be appreciated that the invention is not limited to UNIX workstations operating in a UNIX environment. As a result, at a block 62 the information from the information fields 36 of the template 32 is input to a suitable environment, such as a UNIX environment, and is transferred to a file that is suitable for processing in that environment. Any computing environment suitable for performing finite element model generation is acceptable and may be employed by the invention. For example, other suitable computing environments include Windows-based environments and Macintosh environments. In one embodiment of the invention, a PATRAN programming code language script is used to transfer data from the template 32, generated on a CATIA workstation, to a UNIX workstation. As a result, identified geometry is now in a suitable format for further processing by the host platform 10 to generate a finite element model.

At a block 64 the properties and material input file is automatically processed. A suitable file, such as a series of FORTRAN executable files, is executed at the block 64. At the block 64, the properties and material file, such as a *.txt file, is read and is automatically processed into a suitable file, such as a *.prop file, that can be accessed for a MSC/NASTRAN bulkdata deck for a finite element model.

At a block 66, surfaces of a finite element model of the component 34 are generated. At the block 66, an executable file, such as an executable PATRAN file or FORTRAN executable file or the like, automatically creates nodes and elements that mathematically define structure of the component 34 based on the geometrical input file, such as a *.ft11 file. Executable files for generating surfaces, that is nodes and elements that mathematically define structure, are well known in the art. An explanation of such an executable files is not necessary for an understanding of the invention. It will be appreciated that the blocks 64 and 66 may be performed simultaneously, if desired.

FIG. 5B shows a routine 68 for generating a finite element model for a component 34 when the geometry input file and the properties and material input file have been created without use of the template 32. That is, the geometry input file and the materials and property input file were created either manually or automatically in a CAD environment such as, without limitation, ICAD. The routine 68 is adapted for an automated process. As such, the routine 68 is well adapted for sizing iterations described later. From the blocks 56 and 58 (FIG. 4), the routine 68 proceeds to a block 70 at which the properties and material input file is processed. Processing performed at the block 70 is the same processing previously described for the block 64 (FIG. 5A).

At a block 72, surfaces for the finite element model are generated through creation of nodes and elements that mathematically define the structure of the component 34 based on the geometry input file. Processing performed at the block 72 is the same processing previously described for the block 66 (FIG. 5A).

In addition to being generated in a significantly faster time than is possible using currently known finite element modeling techniques that require input of previously-generated surfaces, finite element models generated according to the invention include highly accurate surfaces. For example, parametric measurements of surfaces generated according to the invention indicate that surface accuracy of greater than 99 percent has been achieved. This is significant because the geometric requirements for generating a finite element model have been simplified to geometric structure represented by points and lines in space that are readily available and created early in design process of a component.

However, as design detail develops greater definition, greater accuracy may be desired or required. In such instances, it may be desirable to adjust surfaces of the finite element model using additional information that becomes available. Because the finite element model has been generated according to the invention significantly earlier in the design process than is possible with currently known finite element model generation methods, refined design data for complex components or user-defined data for components may not be available. However, more information about design of a component may become available as design of the component matures or as the design process continues. The present invention provides a method for updating or refining surfaces of the finite element model when additional information becomes available.

FIG. 5C shows a routine 74 for projecting surfaces of a finite element model that has been generated according to the present invention. At a decision block 76, a determination is made whether or not additional structural definition of geometry of the component 34 in the form of points and lines in space is available. When a determination is made that no such additional information is available, the routine 74 proceeds without further processing. When a determination is made that further data representing points and lines in space are available for defining the geometrical structure of the component 34, the routine 74 proceeds to a block 78. At the block 78, additional information regarding geometrical structure of the component 32 in the form of points and lines in space is input as an appropriate additional geometry input file, such as a *.ft11 file. At a block 80, a surface is spun up from the points and lines in space contained in the additional geometry input file using known techniques, such as a PATRAN or FORTRAN executable file. At a block 82, surfaces generated in the form of points at the blocks 66 and 72 are projected onto the new surface definition generated at the block 80. The points inside the model are updated to represent the change.

The blocks 66, 72, and 82 use a structured number system for grids, elements, properties, and materials. The number system assigns a predetermined range of numbers for subassemblies, properties, materials, and boundaries. The numbering system also applies to individual model numbers, super element definition, and boundary grids and elements. The structured numbering system automates and simplifies further processing of the finite element models. As a result of a structured numbering system, model generation is repeatable and predictable. Models are automatically broken into groups by structural assembly, allowing for quick review, processing, and evaluation. The structured numbering system preassigns interface boundaries between models of components, thus automating integration of models of components into models of assemblies. The structured numbering system further automates breakdown and modification of weights, and allows for complex internal loads processing for automated sizing.

Now that a finite element model for the component 34 has been generated, further checkout of the model, analysis of the model, and integration of the model of the component 34 into a model of an assembly may be performed as desired. These additional processes are discussed below.

(3) Model Checkout

FIG. 6 shows a routine 84 for analysis checkout of a finite element model. Analysis checkout is conducted on the model of the component 34 to ensure the model is free of errors prior to release of the model. The routine 84 performs four checks: (1) visual; (2) elements; (3) analysis; and (4) mass. It will be appreciated, however, that further analysis of the model may be performed as desired.

At a block 86, a visual analysis is performed by the modeler. The model of the component 34 is automatically grouped into its constituent components for visual inspection. The visual inspection performed at the block 86 includes checks for consistency of surface normalcy, consistency of element coordinate systems, beam orientation, and offsets and pin flag.

At a decision block 88, a determination is made whether the visual analysis has been passed successfully. If the visual analysis is not passed, the routine 84 returns to the block 44 for further refinement of the geometrical structure of the component 34.

If the visual analysis is passed as determined at the decision block 88, then at a block 90 an elements analysis is performed. The elements analysis can include an analysis run of skew angle, aspect ratio, wrap, and Jacobian ratio. The block 90 performs gravity runs for the elements analysis. The block 90 is suitably performed by MSC/NASTRAN.

At a decision block 92, a determination is made whether the model of the component 34 passes the elements analysis. If the elements analysis is not passed, then the routine 84 returns to the decision block 44.

If the elements analysis is passed, the routine 84 proceeds to a block 94. At the block 94, analysis is performed on the model of the component 34. A stiffness-deflection check is performed, such as Epsilon value and maximum diagonal ratio. A load balance and boundary conditions check is performed. Also, an Eigen value solution is obtained for rigid body modes with no constraints, and frequency is evaluated. The block 94 is suitably performed by MSC/NASTRAN.

At a decision block 96, a determination is made whether the analysis at the block 94 has been passed. If the analysis is not passed, the routine 84 returns to the decision block 44.

If a determination is made at the decision block 96 that the analysis is passed, the routine 84 proceeds to a block 98 at which a mass analysis is performed. The mass analysis includes a weight summary of the structure generated based on predetermined subassemblies to determine and adjust mass of the component, such as frames, bulkheads, chords, and the like. The mass analysis also generates a table of differences between weight of the model of the component 34 and weight of an actual physical component. The mass analysis also generates a table of differences between center of gravity, if applicable, between a model of the component 32 and an actual physical component. Also, a gravity card is updated to ensure accuracy of weight and center of gravity, if applicable.

Now that a checkout and analysis of the model has been performed, the invention provides for initial loads and sizing of the component model.

(4) Initial Loads and Sizing

FIG. 7 shows a routine 100 for performing initial loads and sizing of a finite element model of the component 34. The routine 100 uses a predetermined number of select, simplified loads cases to ensure proper mass and stiffness representation of the component 34. The routine 100 entails two major processes: (1) defining load sets; and (2) refining sizing of the component 34 using the defined load sets. The routine 100: provides increased confidence in initial design layouts; speeds up the preliminary design process; generates a set of preliminary design loads prior to 25% drawing release; and reduces risks and avoids costs associated with retooling and redesign.

At a block 102, an analysis deck, such as a MSC/NASTRAN bulkdata deck, is generated from the geometrical input file, such as a *.ft11 file, and the properties and materials input file, such as a *.txt file. The analysis deck data has been checked out previously by the routine 84.

At a block 104, a set of applied loads for the component 34 is produced. Because the set of applied loads is produced for initial sizing, it will be appreciated that the set of applied loads produced at the block 104 is a reduced set of loads, such as ultimate and damage-tolerance loads. Representative applied loads produced at the block 104 include, without limitation, gravitational (g) loads, pressure, thermal, sonic, and other typical parameters associated with the component 34. A suitable file, such as a FORTRAN executable file, is executed at the block 104 to produce the set of applied loads.

At a block 106, a set of internal loads is generated. Exemplary internal loads generated include internal forces, stress, and strain. According to the invention, generation of internal loads is standardized according to the numbering system. As a result of such standardizing, generation of loads becomes automated. A suitable file, such as an executable FORTRAN file, or a MSC/NASTRAN file, is executed at the block 106 to produce the set of internal loads.

At a block 108, sizing iteration is performed. The block 108 inputs the set of applied loads from the block 104 and the internal loads from the block 106 and iterates sizing of the component to ensure proper mass and stiffness representation of the component 34. A suitable file, such as a executable FORTRAN file, is executed at the block 108 to perform the sizing iteration.

At a decision block 110, a determination is made whether or not sizing, that is stiffness representation, converges upon predetermined criteria for the set of applied loads generated at the block 104 and the set of internal loads generated at the block 106. The predetermined convergence criteria is suitably a predetermined percent change in stiffness between successive sizing iterations. Given by way of non-limiting example, a suitable set of predetermined convergence criteria includes a five (5) percent change in mass or difference between successive sizing iterations. However, any convergence criteria may be used as desired.

If a determination is made that the predetermined convergence criteria is not met, the routine 100 proceeds to a block 112. At the block 112, the properties and materials input file, such as a *.txt file, is updated with sizing information from the block 108. From the block 112, the routine 100 returns to the routine 40 at the block 44 for generation of another iteration of a finite element model of the component 34. According to the invention, the routine 100 is repeated, and a determination is repeated at the decision block 110 regarding successive iterations. It will be appreciated that the first time the routine 100 is performed, only one iteration is available for the decision block 110. So, the first time the routine 100 is performed, the routine 100 will perform the block 112.

If a determination is made at the decision block 110 that the predetermined convergence criteria is met, the routine 100 ends. The finite element model of the component 34 has been generated, checked out, and initially sized. Next, the finite element models of a plurality of components may be integrated, if desired.

(5) Integrated Finite Element Model Generation

FIG. 8 shows a routine 114 for integrating finite element models of individual components, such as the component 34 and other components, into an integrated finite element model. At a block 116 interface connections between models of components to be integrated are created. Because the invention provides a predetermined numbering system, creation of the interface connections is automated. The predetermined numbering system provides grids for the components to be modeled, and the interface connections are generated at the predetermined grid locations representing predetermined connection points for the components that are interfaced.

At a block 118, an exploded view of the integrated model is generated. Each component model remains intact, but the components that are to be integrated may be spaced apart from each other in the exploded view for visual clarity.

At a block 120, a coincidence check of the integrated model is performed at major interfaces of the components to be integrated. The block 120 ensures that the components to be integrated are connected together properly.

At a block 122, finite element model documentation is generated. The documentation suitably includes reports on integration of the various components.

At a block 124, a load balance is performed for the integrated finite element model. The load balance ensures that loads in equal loads out.

At a block 126, interface loads are released, and the routine 114 ends.

Example of Model Generation

A non-limiting example of finite element model generation, given by way of example only, will now be described. Screen shots within an exemplary, non-limiting graphical user interface (GUI) used in an embodiment of the invention will be referred to in the following description. For example, the following screen shots were generated within a PATRAN GUI, available from MacNeil Schwendler Corporation, running on an IBM RS6000 UNIX workstation. It will be appreciated that use of a GUI renders unnecessary tedious typing, such as that required for creating numerous UNIX commands to invoke sequences of UNIX scripts and for executing FORTRAN programs. However, it will be appreciated that one skilled in the art will be able to create, without undue experimentation, appropriate files outside of a GUI, such as UNIX files or FORTRAN programs, to perform functionality set forth herein.

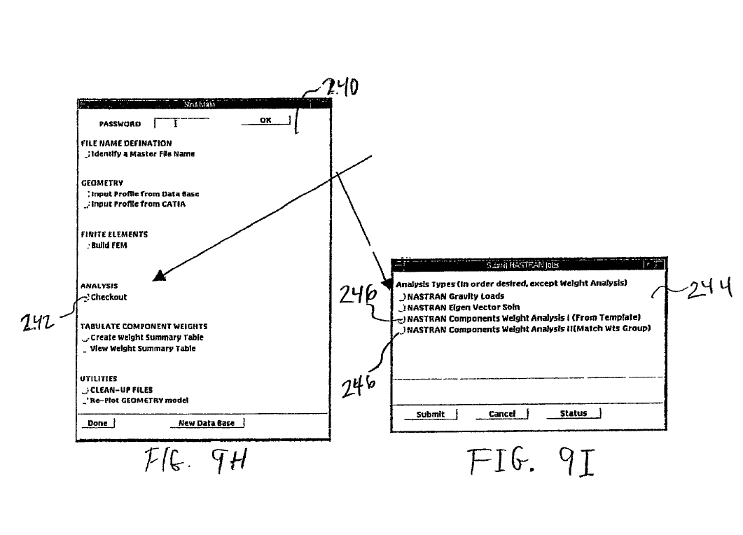

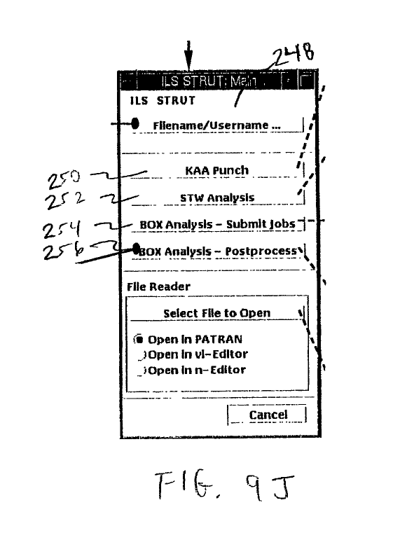

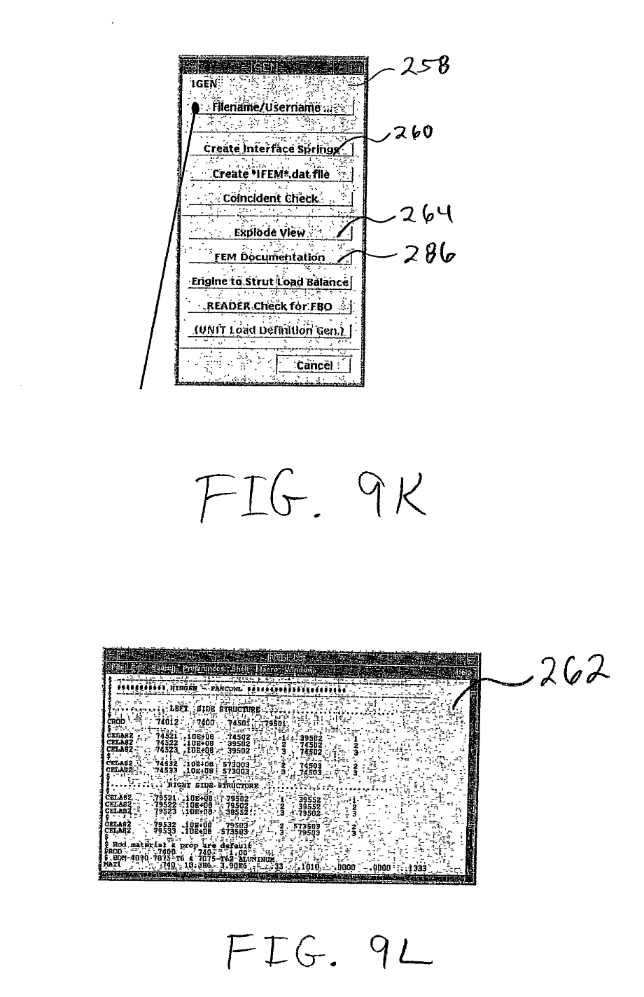

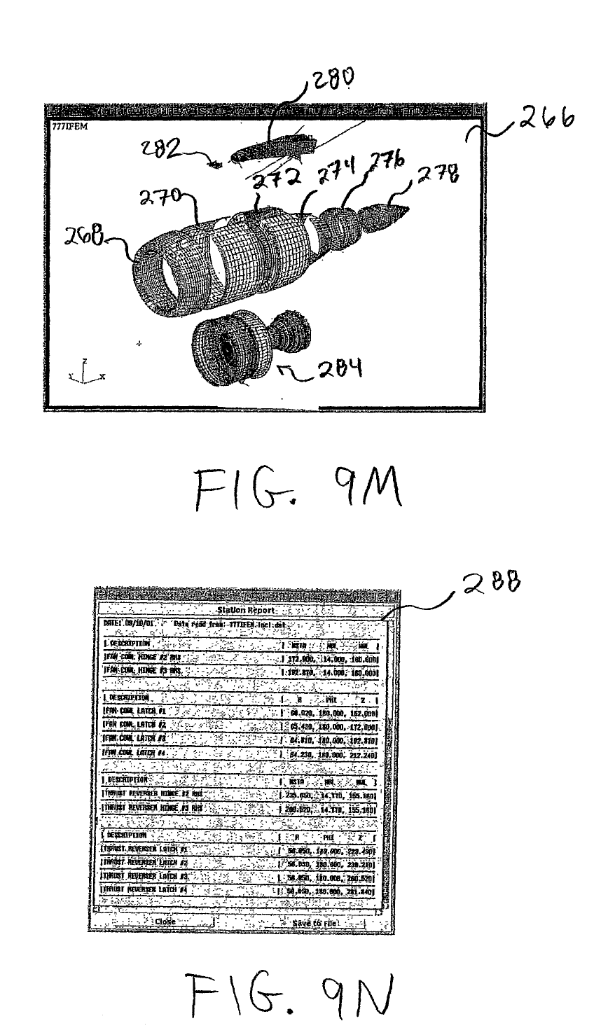

FIG. 9A shows a screen shot of an initial screen 214 at which a selection is made for a type of component that is to be modeled. In this non-limiting example, a strut is selected by inputting the number 9. Selecting a strut invokes the set of predetermined properties and materials rules that define preliminary properties and materials for a strut. If desired, further definition of the component may be selected, as desired. For example, a strut may be further defined as fan or core-mounted.

Once the user has selected the component to be modeled, a GUI is instantiated. For example, FIG. 9B shows an initial screen 216 generated in a PATRAN GUI. It will be appreciated that the GUI can take any form, as desired for a particular application. As is known, logic can be coded into a PATRAN GUI in PATRAN Command Language (PCL). As is also known, a PCL file is executed when PATRAN is used. The GUI includes a plurality of buttons. Each button, when selected, invokes a process. The process selected by the button suitably invokes a PATRAN PCL file, a UNIX file, a series of FORTRAN or C executables, or the like.

FIG. 9C shows a screen 218 at which a button 220 is selected for identifying a master file name. Referring now to FIGS. 9C and 9D, in response to selection of the button 220, a screen 222 is generated at which the user identifies the master file name in a field 224. The files can be input from various sources, such as for example, CATIA; a database of pre-defined geometrical structure input files and properties and material input files; or a user-defined working directory. For example, inputting files from a user-defined working directory permits inputting the geometry input file and the properties and material input file from any source. As described above, the files in the user-defined working directory are suitably generated either manually or automatically in a CAD environment, such as ICAD.

FIG. 9E shows a screen 226 at which a user selects a button 228 to input the two-dimensional diagram 38 in a suitable format, such as a CATIA file. Alternately, a user selects a button 230 to input a geometry input file in a suitable form, such as an ASCII file, from a database.

Referring now to FIGS. 9E and 9F, a screen 232 is generated in response to selection of the button 228. Selection of a button invokes the routine 40 for extracting data from the template 32.

FIG. 9G shows a screen 236 at which a user selects a button 238 to generate a finite element model of the component 32. In response to selection of the button 238, PATRAN instantiates a suitable executable code, such as a UNIX file, a series of FORTRAN executables, and a PCL file, to generate the model. Selection of the button 238 invokes the routine 60 (FIG. 5A) when the button 228 (FIG. 9E) is selected. Alternately, selection of the button 238 invokes the routine 68 (FIG. 5B) when the button 230 (FIG. 9E) is selected.

FIG. 9H shows a screen 240 at which a button 242 is selected, if desired, to perform checkout analysis. Selection of the button 242 invokes the routine 84 (FIG. 6). It will be appreciated that, for a dynamic analysis, proper mass must be assigned in addition to proper stiffness representation. Accordingly, as shown in FIG. 9I, a screen 244 includes buttons 246 for selecting a process for checking and adjusting weights.

FIG. 9J shows a screen 248 at which a user selects processes for invoking the routine 100 (FIG. 7) for initial loads and sizing. A button 250 is selected to generate a stiffness matrix. A button 252 is selected to perform an analysis for ultimate and damage tolerance loads. A button 254 is selected to perform an analysis of whether or not box structures are intact or have failed. A button 256 is selected to perform post-processing of selected box structure that is either intact or has failed, if desired.

FIG. 9K shows a screen 258 at which a user selects processes for performing integrated finite element model generation. A button 260 is selected for creating interface connections. In response to selection of the button 260, a screen 262 (FIG. 9L) is generated. The screen 262 shows descriptions of the interfaces generated at the block 116 (FIG. 8).

Referring back to FIG. 9K, a button 264 is selected to generate an exploded view of the integrated finite element model. FIG. 9M shows a screen 266 that includes an exploded view of an integrated finite element model. For example, the screen 266 shows an exploded view of models of an inlet 268, a fan cowl 270, a thrust reverser 272, an aft cowl 274, a nozzle 276, a plug 278, a strut 280, a fan cowl support beam 282, and an engine 284.

Referring back to FIG. 9K, a button 286 is selected to generate finite element model documentation. Selection of the button 286 invokes the block 122 (FIG. 8), and results in a screen 288 (FIG. 9N).

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method for automatically generating a finite element model of a component, the method comprising:
inputting a two-dimensional diagram of points and lines that represent geometry of a component;
creating a first input file from the two-dimensional diagram, the first input file defining geometrical structure of the component;
creating a second input file that defines properties and materials of the component, the properties and materials being defined responsive to the geometrical structure of the component, the properties and materials being further defined according to a predetermined set of properties and materials rules for the component; and
generating a finite element model of the component from the defined geometrical structure of the component and the defined properties and materials of the component.

2. The method of claim 1, wherein the finite element model generates surface definition of the component.

3. The method of claim 1, wherein the first input file is created by defining a rule-based template.

4. The method of claim 3, wherein the rule-based template is automatically defined.

5. The method of claim 3, wherein the rule-based template is manually defined.

6. The method of claim 1, wherein creating the first input file further includes generating layers of geometric structure.

7. The method of claim 1, wherein creating the first input file further includes creating an ASCII file and creating the second input file further includes creating a text file, wherein generating the finite element model inputs the ASCII file and the text file.

8. The method of claim 1, wherein the first input file is an ASCII file and the second input file is a text file that are created manually from the two-dimensional diagram, and wherein generating the finite element model inputs the ASCII file and the text file.

9. The method of claim 2, further comprising projecting the surface definition of the component onto an additional surface.

10. The method of claim 9, wherein the additional surface is user-defined.

11. The method of claim 1, wherein the properties include mass.

12. The method of claim 1, wherein the properties include stiffness.

13. The method of claim 1, wherein generating the finite element model includes use of a predetermined numbering system for grids, elements, properties, and materials of the component.

14. The method of claim 13, wherein the model is automatically grouped into structural assemblies.

15. The method of claim 13, wherein the model automatically assigns predetermined interface boundaries.

16. The method of claim 1, further comprising performing a visual check of the component model.

17. The method of claim 16, wherein the visual check includes checking consistency of normalcy of surfaces.

18. The method of claim 16, wherein the visual check includes checking consistency of coordinate systems of elements.

19. The method of claim 16, wherein the visual check includes checking beam orientation.

20. The method of claim 16, wherein the visual check includes a check of offsets.

21. The method of claim 1, further comprising performing a check of elements.

22. The method of claim 21, wherein the check of elements includes a check of skew angle.

23. The method of claim 21, wherein the check of elements includes a check of aspect ratio.

24. The method of claim 21, wherein the check of elements includes a check for wrap.

25. The method of claim 21, wherein the check of elements includes a check of Jacobian ratio.

26. The method of claim 1, further comprising analyzing the finite element model.

27. The method of claim 26, wherein analyzing the finite element model includes frequency analysis.

28. The method of claim 26, wherein analyzing the finite element model includes displacement analysis.

29. The method of claim 26, wherein analyzing the finite element model performing a load balance.

30. The method of claim 1, further comprising performing a mass analysis.

31. The method of claim 30, wherein the mass analysis creates a weight summary of the generated component structure.

32. The method of claim 30, wherein the mass analysis calculates a difference between weight of the finite element model and weight of an actual structure.

33. The method of claim 30, wherein the mass analysis calculates a difference between center of gravity of the finite element model and center of gravity of an actual structure.

34. The method of claim 1, further comprising creating applied loads and internal loads for the component.

35. The method of claim 34, further comprising performing a sizing iteration of the component.

36. The method of claim 35, wherein stiffness that results from successive sizing iterations converges within a predetermined difference of stiffness.

37. The method of claim 1, wherein a finite element model is generated for each of a plurality of components, and wherein the finite element models of the components are interfaced at predetermined interface connections.

38. Computer readable medium for automatically generating a finite element model of a component, the computer readable medium comprising:
computer readable medium for inputting a two-dimensional diagram of points and lines that represent geometry of a component;
computer readable medium for creating a first input file from the two-dimensional diagram, the first input file defining geometrical structure of the component;
computer readable medium for creating a second input file that defines properties and materials of the component, the properties and materials being defined responsive to the geometrical structure of the component, the properties and materials being further defined according to a predetermined set of properties and materials rules for the component; and
computer readable medium generating a finite element model of the component from the defined geometrical structure of the component and the defined properties and materials of the component.

39. The computer readable medium of claim 38, wherein the computer readable medium for the finite element model generates surface definition of the component.

40. The computer readable medium of claim 39, wherein the first input file is created by defining a rule-based template.

41. The computer readable medium of claim 40, wherein the rule-based template is automatically defined.

42. The computer readable medium of claim 40, wherein the rule-based template is manually defined.

43. The computer readable medium of claim 38, wherein the computer readable medium for creating the first input file further includes computer readable medium for generating layers of geometric structure.

44. The computer readable medium of claim 38, wherein the computer readable medium for creating the first input file further includes computer readable medium for creating an ASCII file, and the computer readable medium for creating the second input file further includes computer readable medium creating a text file, wherein the computer readable medium generating the finite element model inputs the ASCII file and the text file.

45. The computer readable medium of claim 38, wherein the first input file is an ASCII file and the second input file is a text file that are created manually from the two-dimensional diagram, and wherein the computer readable medium for generating the finite element model inputs the ASCII file and the text file.

46. The computer readable medium of claim 39, further comprising computer readable medium for projecting the surface definition of the component onto an additional surface.

47. The computer readable medium of claim 46, wherein the additional surface is user-defined.

48. The computer readable medium of claim 38, wherein the properties include mass.

49. The computer readable medium of claim 38, wherein the properties include stiffness.

50. The computer readable medium of claim 38, wherein the computer readable medium for generating the finite element model includes a predetermined numbering system for grids, elements, properties, and materials of the component.

51. The computer readable medium of claim 50, wherein the model is automatically grouped into structural assemblies.

52. The computer readable medium of claim 50, wherein the model automatically assigns predetermined interface boundaries.

53. The computer readable medium of claim 38, further comprising computer readable medium for performing a visual check of the component model.

54. The computer readable medium of claim 53, wherein the visual check includes checking consistency of normalcy of surfaces.

55. The computer readable medium of claim 53, wherein the visual check includes checking consistency of coordinate systems of elements.

56. The computer readable medium of claim 53, wherein the visual check includes checking beam orientation.

57. The computer readable medium of claim 53, wherein the visual check includes a check of offsets.

58. The computer readable medium of claim 38, further comprising computer readable medium for performing a check of elements.

59. The computer readable medium of claim 58, wherein the check of elements includes a check of skew angle.

60. The computer readable medium of claim 58, wherein the check of elements includes a check of aspect ratio.

61. The computer readable medium of claim 58, wherein the check of elements includes a check for wrap.

62. The computer readable medium of claim 58, wherein the check of elements includes a check of Jacobian ratio.

63. The computer readable medium of claim 38, further comprising computer readable medium for analyzing the finite element model.

64. The computer readable medium of claim 63, wherein analysis of the finite element model includes frequency analysis.

65. The computer readable medium of claim 63, wherein analysis of the finite element model includes displacement analysis.

66. The computer readable medium of claim 63, wherein analysis of the finite element model includes a load balance.

67. The computer readable medium of claim 38, further comprising computer readable medium for performing a mass analysis.

68. The computer readable medium of claim 67, wherein the mass analysis creates a weight summary of the generated component structure.

69. The computer readable medium of claim 67, wherein the mass analysis calculates a difference between weight of the finite element model and weight of an actual structure.

70. The computer readable medium of claim 67, wherein the mass analysis calculates a difference between center of gravity of the finite element model and center of gravity of an actual structure.

71. A system for automatically generating a finite element model of a component, the computer readable medium comprising:
means for inputting a two-dimensional diagram of points and lines that represent geometry of a component;
means for creating a first input file from the two-dimensional diagram, the first input file defining geometrical structure of the component;
means for creating a second input file that defines properties and materials of the component, the properties and materials being defined responsive to the geometrical structure of the component, the properties and materials being further defined according to a predetermined set of properties and materials rules for the component; and
means for generating a finite element model of the component from the defined geometrical structure of the component and the defined properties and materials of the component.

72. The system of claim 71, wherein the means for generating the finite element model generates surface definition of the component.

73. The system of claim 71, wherein the first input file is created by defining a rule-based template.

74. The system of claim 73, wherein the rule-based template is automatically defined.

75. The system of claim 73, wherein the rule-based template is manually defined.

76. The system of claim 71, wherein the means for creating the first input file further includes a method for generating layers of geometric structure.

77. The system of claim 71, wherein the method for creating the first input file further includes means for creating an ASCII file, and the means for creating the second input file further includes means for creating a text file, wherein the means for generating the finite element model inputs the ASII file and the text file.

78. The system of claim 71, wherein the first input file is an ASCII file and the second input file is a text file that are created manually from the two-dimensional diagram, and wherein the means for generating the finite element model inputs the ASCII file and the text file.

79. The system of claim 72, further comprising means for projecting the surface definition of the component onto an additional surface.

80. The system of claim 79, wherein the additional surface is user-defined.

81. The system of claim 71, wherein the properties include mass.

82. The system of claim 71, wherein the properties include stiffness.

83. The system of claim 71, wherein the means for generating the finite element model includes a predetermined numbering system for grids, elements, properties, and materials of the component.

84. The system of claim 83, wherein the model is automatically grouped into structural assemblies.

85. The system of claim 83, wherein the model automatically assigns predetermined interface boundaries.

86. The system of claim 71, further comprising means for performing a visual check of the component model.

87. The system of claim 86, wherein the visual check includes checking consistency of normalcy of surfaces.

88. The system of claim 86, wherein the visual check includes checking consistency of coordinate systems of elements.

89. The system of claim 86, wherein the visual check includes checking beam orientation.

90. The system of claim 86, wherein the visual check includes a check of offsets.

91. The system of claim 71, further comprising means for performing a check of elements.

92. The system of claim 91, wherein the check of elements includes a check of skew angle.

93. The system of claim 91, wherein the check of elements includes a check of aspect ratio.

94. The system of claim 91, wherein the check of elements includes a check for wrap.

95. The system of claim 91, wherein the check of elements includes a check of Jacobian ratio.

96. The system of claim 71, further comprising means for analyzing the finite element model.

97. The system of claim 96, wherein analysis of the finite element model includes frequency analysis.

98. The system of claim 96, wherein analysis of the finite element model includes displacement analysis.

99. The system of claim 96, wherein analysis of the finite element model includes a load balance.

100. The system of claim 71, further comprising means for performing a mass analysis.

101. The system of claim 100, wherein the mass analysis creates a weight summary of the generated component structure.

102. The system of claim 100, wherein the mass analysis calculates a difference between weight of the finite element model and weight of an actual structure.

103. The system of claim 100, wherein the mass analysis calculates a difference between center of gravity of the finite element model and center of gravity of an actual structure.
